(19) United States
(12) Patent Application Publication
(10) Pub. No.: US 2024/0258510 A1
(43) Pub. Date: Aug. 1, 2024

(54) Metal-Metal and Liquid-Solid Composites and Methods of Making and Using Thereof

(71) Applicant: THE TEXAS A&M UNIVERSITY SYSTEM, College Station, TX (US)

(72) Inventors: Charles David BORENSTEIN, College Station, TX (US); James David PARAMORE, Bryan, TX (US); Karl Theodore HARTWIG, Colleg Station, TX (US); Brady Glenn BUTLER, College Station, TX (US); Michael Jan DEMKOWICZ, College Station, TX (US)

(21) Appl. No.: 18/424,062

(22) Filed: Jan. 26, 2024

Related U.S. Application Data
(60) Provisional application No. 63/481,690, filed on Jan. 26, 2023.

(51) Int. Cl. H01M 4/38; H01M 10/39

(52) U.S. Cl. CPC H01M 4/38; H01M 10/399; H01M 2300/0091

(57) ABSTRACT

Described herein are composites, including metal-metal composites and liquid-solid composites, that exhibit improved properties. Also provided are methods of making and using these composites.

### CROSS-REFERENCE TO RELATED APPLICATIONS

This application claims benefit of priority of U.S. Provisional Application No. 63/481,690, filed Jan. 26, 2023, which is incorporated herein by reference.

### STATEMENT REGARDING FEDERALLY SPONSORED RESEARCH OR DEVELOPMENT

This invention was made with Government Support under Grant No. DE-NA0003857 awarded by the United States Department of Energy, National Nuclear Security Administration (DOE/NNSA). The Government has certain rights in the invention.

### BACKGROUND

Composites can be used to produce materials with properties superior to their constituents. For example, in the case of polymer composites, the incorporation of a filler (e.g., glass particles) within a polymer can strengthen the composite while still leaving it tough and lightweight. While many composites have been explored, there remains a need for composites with improved properties for a wide variety of applications.

### SUMMARY

Provided herein are composites, including metal-metal composites and liquid-solid composites, that exhibit improved properties. Also provided are methods of making and using these composites.

For example, provided herein are metal-metal composites that exhibit improved interphase bonding as the result of the incorporation of a small quantity of an active metal. While the small amount of active metal has a significant impact on interphase bonding, a negligible impact on the principal phases was observed. By way of example, metal-metal composites were prepared by blending and sintering together non-compounding metals (e.g., copper and tantalum) with an active metal (e.g., Ti) or compounds containing active metals. The resulting composites exhibited superior strength and ductility as compared to analogous composites containing the same atomic ratio of non-compounding metals but lacking the active metal. If desired, the composites can be subsequently processed by severe plastic deformation (SPD) techniques, such as equal channel angular extrusion (ECAE), to alter their microstructure and mechanical properties.

For example, provided herein are metal-metal composites that comprise a heterogeneous mixture of a first metal, a second metal, and an active metal, wherein the active metal is present in an effective amount to improve interphase bonding between the first metal and the second metal as compared to a composite containing the first metal and the second metal in an equivalent atomic ratio, but lacking the active metal.

The relative proportions of the first metal and the second metal present in the composite can vary. In some embodiments, the first metal can be present in the composite in an amount of from 10 at. % to 90 at. %, based on a total number of atoms present in the composite, and the second metal can be present in the composite in an amount of from 90 at. % to 10 at. %, based on a total number of atoms present in the composite.

In some embodiments, the first metal can be chosen from Cu, Ag, and Au. In certain embodiments, the first metal can comprise Cu.

In some embodiments, the second metal is chosen from Ta, Nb, V, W, Cr, and Mo. In certain embodiments, the second metal can comprise Ta. In certain embodiments, the second metal can comprise Nb. In certain embodiments, the second metal can comprise W.

In some embodiments, the active metal can be present in the composite in an amount of from 0.1 at. % to 5 at. % (e.g., from 0.1 at. % to 3 at. %), based on the total number of atoms present in the composite.

In some embodiments, the active metal can be chosen from Ti, Zr, B, Hf, Mg, La, Sc, Y, Ce, and Be. In certain embodiments, the active metal can comprise Ti. In certain embodiments, the active metal can comprise Zr.

In some embodiments, the first metal comprises Cu and the second metal comprises Ta (i.e., the composite comprises a Cu—Ta composite). In certain of these embodiments, the active metal comprises Ti. In certain of these embodiments, the active metal comprises Zr.

In some embodiments, the first metal comprises Cu and the second metal comprises W (i.e., the composite comprises a Cu—W composite). In certain of these embodiments, the active metal comprises Ti. In certain of these embodiments, the active metal comprises Zr.

In some embodiments, the first metal comprises Cu and the second metal comprises Nb (i.e., the composite comprises a Cu—Nb composite). In certain of these embodiments, the active metal comprises Ti. In certain of these embodiments, the active metal comprises Zr.

In certain embodiments, the composite can comprise: from 10 at. % to 90 at. % Cu, based on the total number of atoms present in the composite; from 90 at. % to 10 at. % Ta, based on the total number of atoms present in the composite; and from 0.1 at. % to 3 at. % Ti, based on the total number of atoms present in the composite.

Without wishing to be bound by theory, the active metal can be localized at boundaries between the first metal and the second metal, where it improves interphase bonding between the first metal and the second metal. In some embodiments, the active metal can be present at elevated concentrations at boundaries between the first metal and the second metal as compared to concentrations of the active metal in bulk regions of the first metal and the second metal, as evidenced by EDS measurements of the composite material.

In some embodiments, the composite can be formed by a method that comprises severe plastic deformation (SPD), such as equal channel angular extrusion (ECAE). In certain embodiments when the composite is formed by a method that comprises SPD, grains of the first metal and grains of the second metal exhibit increased co-deformation, as assessed by backscatter scanning electron microscopy (SEM), as compared to grains of the first metal and grains of the second metal in a composite containing the first metal and the second metal in an equivalent atomic ratio, but lacking the active metal.

In some embodiments, the composite exhibits improved yield strength, improved tensile strength, improved elongation to failure, improved fracture toughness, or a combination thereof as compared to a composite containing the first metal and the second metal in an equivalent atomic ratio, but lacking the active metal.

The metal-metal composites described herein can exhibit tailored microstructures and properties. These multiphase metal-metal composites can find use in a range of applications, including for example, as wear resistant conductors (e.g., for cycling electrical switches), high strength thermal conductors (e.g., for use in heat exchangers and boilers), and high-strength, wear resistant materials for miliary applications (e.g., rail gun rails, kinetic energy penetrators, and shaped charge liners).

Also provided herein are methods of preparing metal-metal composite. These methods can comprise subjecting a mixture comprising a first metal, a second metal, and an active metal to a severe plastic deformation (SPD) process, wherein the active metal is present in an effective amount to improve interphase bonding between the first metal and the second metal as compared to a composite containing the first metal and the second metal in an equivalent atomic ratio, but lacking the active metal.

In some embodiments, the mixture comprising the first metal, the second metal, and the active metal can be prepared by blending and sintering the metal, the second metal, and the active metal.

Also provided are liquid-solid composites. These multi-metal and metal-ceramic composite systems can retain their shape, even when the majority phase of the liquid-solid composites is a liquid (e.g., a molten metal or electrolyte). By way of example, liquid-solid composites were produced from mixtures of copper and tantalum, calcium and tantalum, and bismuth and tantalum powders. In these composites, both metal phases were continuous, and the metal phases were intertwined (intermixed). In these examples, tantalum exhibits a significantly higher melting point than copper, calcium, or bismuth. Thus, when the composite is heated to a temperature above the melting temperature of the lower melting point component of the composite (copper, calcium, or bismuth) but below the melting point of the higher melting point component of the composite (tantalum), the lower melting point component is a molten fluid while the higher melting point component acts as a solid skeleton. This solid skeleton provides structural integrity, allowing the composite to retain its shape even when a force (compression or tension) is applied to the composite (and even when 75% by volume or more of the composite is a molten liquid).

For example, provided herein are liquid-solid composites that comprise a continuous liquid phase comprising a first metal intertwined with a continuous solid refractory phase.

The liquid-solid composite can be at a temperature that is above the melting point of the first metal and below the melting point of the solid refractory phase. In some embodiments, the first metal can have a melting point that is at least 100° F. below a melting point of the solid refractory phase.

In some embodiments, the first metal can have a melting point of from 400° F. to 2,000° F. In some embodiments, the solid refractory phase can have a melting point of 2,100° F. or more (e.g., 2,500° F. or more, such as from 2,100° F. to 6,200° F., or from 2,500° F. to 6,200° F.).

In some embodiments, the first metal can be chosen from Cu, Bi, Ca, Au, and Ag.

In some embodiments, the solid refractory phase comprises a second metal. For example, in some embodiments, the solid refractory phase can comprise a second metal chosen from Ta, Fe, steel, Nb, Mo, and W. In other embodiments, the solid refractory phase comprises a ceramic. For example, in some embodiments, the solid refractory phase can comprise a ceramic chosen from alumina, silica, and yittria.

The relative proportions of the continuous liquid phase and the solid refractory phase present in the composite can vary. In some embodiments, the continuous liquid phase comprises from 60% by volume to 98% by volume of the liquid-solid composite.

This ability of these composites to exhibit certain properties of a liquid metal while still retaining their shape/structural integrity renders these composites particularly suitable for use in liquid metal batteries. Currently, liquid metal batteries are known for their efficiency and long life span. However, many liquid metal battery designs rely on buoyancy to separate their electrodes and electrolyte. As a result, many liquid metal batteries are limited to stationary applications, as movement can cause the electrodes to come into contact with one another and form an electrical short. The liquid-solid composites described herein can be used as electrodes, eliminating this problem with many existing electrodes used in liquid metal batteries.

Accordingly, provided herein is an electrode for use in an electrochemical cell comprising a liquid-solid composite described herein. Also provided are electrochemical cells comprising an anode, a cathode, and an electrolyte in electrochemical contact with the anode and the cathode; wherein the anode, the cathode, or a combination thereof comprise a liquid-solid composite described herein.

Also provided herein are liquid-solid composites comprising a continuous liquid phase comprising a molten electrolyte intertwined with a continuous solid refractory phase.

The liquid-solid composite can be at a temperature that is above the melting point of the electrolyte and below the melting point of the solid refractory phase. In some embodiments, the electrolyte can have a melting point that is at least 100° F. below a melting point of the solid refractory phase.

In some embodiments, the electrolyte can have a melting point of from 400° F. to 2,000° F. In some embodiments, the solid refractory phase can have a melting point of 2,100° F. or more (e.g., 2,500° F. or more, such as from 2,100° F. to 6,200° F., or from 2,500° F. to 6,200° F.).

In some embodiments, the electrolyte can be chosen from one or more metal halides, one or more metal carbonates, one or more metal oxides, or a combination thereof.

In some embodiments, the solid refractory phase comprises a metal. For example, in some embodiments, the solid refractory phase can comprise a metal chosen from Ta, Fe, steel, Nb, Mo, and W. In other embodiments, the solid refractory phase comprises a ceramic. For example, in some embodiments, the solid refractory phase can comprise a ceramic chosen from alumina, silica, and yittria.

The relative proportions of the continuous liquid phase and the solid refractory phase present in the composite can vary. In some embodiments, the continuous liquid phase comprises from 60% by volume to 98% by volume of the liquid-solid composite.

These composites can be used, for example, in electrolytes in liquid metal batteries. Accordingly, provided herein is an electrolyte for use in an electrochemical cell comprising a liquid-solid composite described herein. Also provided are electrochemical cells comprising an anode, a cathode, and an electrolyte in electrochemical contact with the anode and the cathode; wherein the electrolyte comprises a liquid-solid composite described herein.

### DESCRIPTION OF DRAWINGS

FIGS. 1A-1B illustrate heat treatment schedules of for CuTa (FIG. 1A) and CuTaM (FIG. 1B).

FIG. 2 illustrates an example miniature tension sample (dimensions in mm).

FIGS. 3A-3E show a schematic of a an ECAE die (FIG. 3A), as well as backscatter SEM images of (FIG. 3B) as-sintered Cu75Ta25, (FIG. 3C) as-sintered Cu75Ta25M, (FIG. 3D) Cu75Ta25 after one extrusion, (FIG. 3E) Cu75Ta25M after one extrusion.

FIGS. 4A-4F show an EDS elemental map of the IA Cu75Ta25M composite, with (FIG. 4A) showing all results in this area, (FIG. 4B) tantalum, (FIG. 4C) titanium, (FIG. 4D) copper, (FIG. 4E) oxygen, and (FIG. 4F) the EDS output spectrum, in eV.

FIGS. 5A-5F show backscatter SEM images of as-sintered samples. FIGS. 5A-5B show backscatter SEM images of as-sintered (FIG. 5A) Cu50Ta50M and (FIG. 5B) Cu25Ta75. For both nominal Ta contents there is little visible microstructural difference between the modified and unmodified composite after sintering. After one extrusion pass (1A), there was little Ta deformation in the Cu50Ta50 (FIG. 5C) or Cu25Ta75 (FIG. 5D). There was substantial deformation in Ta the Cu50Ta50M (FIG. 5E) and Cu25Ta75M (FIG. 5F).

FIGS. 6A-6D summarize the tensile properties for composites (FIGS. 6A-6C) along with a representative engineering stress-engineering strain curves for 25 vol. % Ta composite (FIG. 6D). Error bars represent one standard deviation of the plotted quantity.

FIGS. 7A-7D show fracture surfaces of Cu75Ta25 composites imaged in (FIG. 7A) backscatter and (FIG. 7B) secondary electron mode. Fracture surfaces of Cu75Ta25M composites imaged in (FIG. 7C) backscatter and (FIG. 7D) secondary electron mode.

FIGS. 8A-8D show nano-hardness for the copper, tantalum, and Cu—Ta interface of CuTa and CuTaM composites (FIGS. 8A-8C), with one standard deviation error bars and a SEM backscatter image of a typical grid of nano-indents (FIG. 8D). Copper indents were identified as those that fell wholly within the copper phase (dark phase), tantalum indents those that were entirely within the tantalum phase (bright phase), and all indents whose projected areas included both were labeled as interface.

FIG. 9 shows mini-tension results for 1A and 4A Cu75Ta25M along the normal direction. Sample numbers indicate the specific tensile test sample that the data was taken from.

FIG. 10 compares the nano-hardness of Cu75Ta25M after 1A and 4A extrusions.

FIG. 11 compares the nano-hardness in 1A Cu75Ta25M along different orientations. Little difference was noted in the material.

FIG. 12 is an EBSD map of IA Cu50Ta50M, with copper grains shown. The grains can be seen to be relatively equiaxed, with diameters of a few microns.

FIGS. 13A-13B show, from left to right in FIG. 13A; Cu75Ta25, Cu75Ta25M, and copper alloy 122 tube, prior to heat treatment at 1200° C.; and from left to right in FIG. 13B; Cu75Ta25, Cu75Ta25M, and copper alloy 122 tube, after heat treatment at 1200° ° C. The copper tube has clearly melted, while the two composite samples have maintained their shape.

FIGS. 14A-14D show a Cu75Ta25 sample before and after testing at 1200° C. The sample was machined to fit in the fixture without touching its sides (FIG. 14A). After testing, it retained its shape (FIG. 14B) and did not swell or sag to the point that it touched the interior of the fixture (FIG. 14C). As seen in a polished cross section (FIG. 14D), the sample had limited contact with the fixture and was able to maintain its strength despite the development of porosity.

FIG. 15 shows DSC results for Cu75Ta25. The endothermic and exothermic peaks indicate that the copper melted at approximately 1084° C., and solidified at approximately 1075° C., respectively.

FIGS. 16A-16C illustrate a Bi75Ta25 composite after sintering. Bismuth droplets are visible on the as-sintered composite (FIG. 16A). Some porosity, likely attributable to tantalum loss during polishing, is visible in the core microstrucure of the composite (FIG. 16B). Ca75Ta25 composite, after sintering (FIG. 16C).

FIGS. 17A-17B illustrate an example Ca75Ta25-Bi75Ta25 battery. FIG. 17A shows an assembled Ca75Ta25-Bi75Ta25 battery. The composite electrolytes are inside the steel containers. Each container is open at one end, with the open ends facing each other. The ability of the electrodes to operate in this configuration is further proof of the high temperature stiffness of these composites. The visible white powder in the crucible is the mixed chloride electrolyte. The measured voltage of the assembled cell can be seen in FIG. 17B.

### DETAILED DESCRIPTION

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

It is to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 11/2, and 43/4 This applies regardless of the breadth of the range.

The term “about,” as used herein, refers to variation in the numerical quantity that can occur, for example, through typical measuring techniques and equipment, with respect to any quantifiable variable, including, but not limited to mass, volume, time, temperature, distance, molecular weight, and water permeability. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

### Metal-Metal Composites

Provided herein are metal-metal composites that comprise a heterogeneous mixture of a first metal, a second metal, and an active metal, wherein the active metal is present in an effective amount to improve interphase bonding between the first metal and the second metal as compared to a composite containing the first metal and the second metal in an equivalent atomic ratio, but lacking the active metal.

The relative proportions of the first metal and the second metal present in the composite can vary.

In some embodiments, the first metal can be present in the composite in an amount of at least 10 at. % (e.g., at least 15 at. %, at least 20 at. %, at least 25 at. %, at least 30 at. %, at least 35 at. %, at least 40 at. %, at least 45 at. %, at least 50 at. %, at least 55 at. %, at least 60 at. %, at least 65 at. %, at least 70 at. %, at least 75 at. %, at least 80 at. %, or at least 85 at. %), based on a total number of atoms present in the composite. In some embodiments, the first metal can be present in the composite in an amount of 90 at. % or less (e.g., 85 at. % or less, 80 at. % or less, 75 at. % or less, 70 at. % or less, 65 at. % or less, 60 at. % or less, 55 at. % or less, 50 at. % or less, 45 at. % or less, 40 at. % or less, 35 at. % or less, 30 at. % or less, 25 at. % or less, 20 at. % or less, or 15 at. % or less), based on a total number of atoms present in the composite.

The first metal can be present in the composite in an amount ranging from any of the minimum values described above to any of the maximum values described above. For example, in some embodiments, the first metal can be present in the composite in an amount of from 10 at. % to 90 at. % (e.g., from 20 at. % to 90 at. %, or from 30 at. % to 85 at. %), based on the total weight of the composite.

In some embodiments, the second metal can be present in the composite in an amount of 90 at. % or less (e.g., 85 at. % or less, 80 at. % or less, 75 at. % or less, 70 at. % or less, 65 at. % or less, 60 at. % or less, 55 at. % or less, 50 at. % or less, 45 at. % or less, 40 at. % or less, 35 at. % or less, 30 at. % or less, 25 at. % or less, 20 at. % or less, or 15 at. % or less), based on a total number of atoms present in the composite. In some embodiments, the second metal can be present in the composite in an amount of at least 10 at. % (e.g., at least 15 at. %, at least 20 at. %, at least 25 at. %, at least 30 at. %, at least 35 at. %, at least 40 at. %, at least 45 at. %, at least 50 at. %, at least 55 at. %, at least 60 at. %, at least 65 at. %, at least 70 at. %, at least 75 at. %, at least 80 at. %, or at least 85 at. %), based on a total number of atoms present in the composite.

The second metal can be present in the composite in an amount ranging from any of the minimum values described above to any of the maximum values described above. For example, in some embodiments, the first metal can be present in the composite in an amount of from 90 at. % to 10 at. % (e.g., from 90 at. % to 20 at. %, or from 85 at. % to 30 at. %), based on the total weight of the composite.

The identity of the first metal and the second metal can vary. The first metal and the second metal can be selected, in combination, so as to provide a metal-metal composite possessing the desired combination of chemical and physical properties. In some embodiments, the first metal and second metal can be selected, in combination, such that the first metal and the second metal phase separate. In some embodiments, the first metal and second metal can be selected, in combination, such that the first metal and the second metal do not form intermetallics.

In some embodiments, the first metal can be conductive. In some embodiments, the first metal can comprise a Group 11 element. In some embodiments, the first metal can be chosen from Cu, Ag, and Au. In certain embodiments, the first metal can comprise Cu.

In some embodiments, the second metal can comprise a body-centered cubic (BCC) refractory metal. In some embodiments, the second metal is chosen from Ta, Nb, V, W, Cr, and Mo. In certain embodiments, the second metal can comprise Ta. In certain embodiments, the second metal can comprise Nb.

The active metal can be selected so as to be reactive with both the first metal and the second metal. For example, in some embodiments, the active metal can comprise a metal that diffusion bonds with both the first metal and the second metal, thereby increasing interphase bond strength between the first metal and the second metal. In some embodiments, the active metal can be selected so as to reduce oxides present on the surface of feedstock particles the first metal and/or the second metal, thereby producing clean interphase boundaries.

In some embodiments, the active metal can be present in the composite in an amount greater than 0 at. % (e.g., at least 0.01 at. %, at least 0.05 at %, at least 0.1 at. %, at least 0.15 at. %, at least 0.2 at. %, at least 0.25 at. %, at least 0.3 at. %, at least 0.35 at. %, at least 0.4 at. %, at least 0.45 at. %, at least 0.5 at. %, at least 0.55 at. %, at least 0.6 at. %, at least 0.65 at. %, at least 0.7 at. %, at least 0.75 at. %, at least 0.8 at. %, at least 0.85 at. %, at least 0.9 at. %, at least 0.95 at. %, at least 1 at. %, at least 1.1 at. %, at least 1.2 at. %, at least 1.3 at. %, at least 1.4 at. %, at least 1.5 at. %, at least 1.6 at. %, at least 1.7 at. %, at least 1.8 at. %, at least 1.9 at. %, at least 2 at. %, at least 2.1 at. %, at least 2.2 at. %, at least 2.3 at. %, at least 2.4 at. %, at least 2.5 at. %, at least 2.6 at. %, at least 2.7 at. %, at least 2.8 at. %, at least 2.9 at. %, at least 3 at. %, at least 3.1 at. %, at least 3.2 at. %, at least 3.3 at. %, at least 3.4 at. %, at least 3.5 at. %, at least 3.6 at. %, at least 3.7 at. %, at least 3.8 at. %, at least 3.9 at. %, at least 4 at. %, at least 4.1 at. %, at least 4.2 at. %, at least 4.3 at. %, at least 4.4 at. %, at least 4.5 at. %, at least 4.6 at. %, at least 4.7 at. %, at least 4.8 at. %, or at least 4.9 at. %), based on the total number of atoms present in the composite. In some embodiments, the active metal can be present in the composite in an amount of 5 at. % or less (e.g., 4.9 at. % or less, 4.8 at. % or less, 4.7 at. % or less, 4.6 at. % or less, 4.5 at. % or less, 4.4 at. % or less, 4.3 at. % or less, 4.2 at. % or less, 4.1 at. % or less, 4.0 at. % or less, 3.9 at. % or less, 3.8 at. % or less, 3.7 at. % or less, 3.6 at. % or less, 3.5 at. % or less, 3.4 at. % or less, 3.3 at. % or less, 3.2 at. % or less, 3.1 at. % or less, 3.0 at. % or less, 2.9 at. % or less, 2.8 at. % or less, 2.7 at. % or less, 2.6 at. % or less, 2.5 at. % or less, 2.4 at. % or less, 2.3 at. % or less, 2.2 at. % or less, 2.1 at. % or less, 2.0 at. % or less, 1.9 at. % or less, 1.8 at. % or less, 1.7 at. % or less, 1.6 at. % or less, 1.5 at. % or less, 1.4 at. % or less, 1.3 at. % or less, 1.2 at. % or less, 1.1 at. % or less, 1.0 at. % or less, 0.95 at. % or less, 0.9 at. % or less, 0.85 at. % or less, 0.8 at. % or less, 0.75 at. % or less, 0.7 at. % or less, 0.65 at. % or less, 0.6 at. % or less, 0.55 at. % or less, 0.5 at. % or less, 0.45 at. % or less, 0.4 at. % or less, 0.35 at. % or less, 0.3 at. % or less, 0.25 at. % or less, 0.2 at. % or less, 0.15 at. % or less, 0.1 at. % or less, 0.05 at % or less, or 0.01 at % or less), based on the total number of atoms present in the composite.

The active metal can be present in the composite in an amount ranging from any of the minimum values described above to any of the maximum values described above. For example, in some embodiments, the active metal can be present in the composite in an amount of from 0.1 at. % to 5 at. % (e.g., from 0.1 at. % to 3 at. %), based on the total number of atoms present in the composite.

In some embodiments, the active metal can comprise a hexagonal close-packed (HCP) metal. In some embodiments, the active metal can be chosen from Ti, Zr, B, Hf, Mg, La, Sc, Y, Ce, and Be. In certain embodiments, the active metal can comprise Ti. In certain embodiments, the active metal can comprise Zr.

In some examples, the first metal comprises Cu and the second metal comprises Ta (i.e., the composite comprises a Cu—Ta composite). In certain of these examples, the active metal comprises Ti. In certain of these examples, the active metal comprises Zr.

In some examples, the first metal comprises Cu and the second metal comprises W (i.e., the composite comprises a Cu—W composite). In certain of these examples, the active metal comprises Ti. In certain of these examples, the active metal comprises Zr.

In some examples, the first metal comprises Cu and the second metal comprises Nb (i.e., the composite comprises a Cu—Nb composite). In certain of these examples, the active metal comprises Ti. In certain of these examples, the active metal comprises Zr.

In certain examples, the composite can comprise: from 10 at. % to 90 at. % Cu, based on the total number of atoms present in the composite; from 90 at. % to 10 at. % Ta, based on the total number of atoms present in the composite; and from 0.1 at. % to 3 at. % Ti, based on the total number of atoms present in the composite.

In certain examples, the composite can comprise: from 10 at. % to 90 at. % Cu, based on the total number of atoms present in the composite; from 90 at. % to 10 at. % Ta, based on the total number of atoms present in the composite; and from 0.1 at. % to 3 at. % Zr, based on the total number of atoms present in the composite.

In certain examples, the composite can comprise: from 10 at. % to 90 at. % Cu, based on the total number of atoms present in the composite; from 90 at. % to 10 at. % W, based on the total number of atoms present in the composite; and from 0.1 at. % to 3 at. % Ti, based on the total number of atoms present in the composite.

In certain examples, the composite can comprise: from 10 at. % to 90 at. % Cu, based on the total number of atoms present in the composite; from 90 at. % to 10 at. % W, based on the total number of atoms present in the composite; and from 0.1 at. % to 3 at. % Zr, based on the total number of atoms present in the composite.

In certain examples, the composite can comprise: from 10 at. % to 90 at. % Cu, based on the total number of atoms present in the composite; from 90 at. % to 10 at. % Nb, based on the total number of atoms present in the composite; and from 0.1 at. % to 3 at. % Ti, based on the total number of atoms present in the composite.

In certain examples, the composite can comprise: from 10 at. % to 90 at. % Cu, based on the total number of atoms present in the composite; from 90 at. % to 10 at. % Nb, based on the total number of atoms present in the composite; and from 0.1 at. % to 3 at. % Zr, based on the total number of atoms present in the composite.

Without wishing to be bound by theory, the active metal can be localized at boundaries between the first metal and the second metal, where it improves interphase bonding between the first metal and the second metal. In some embodiments, the active metal can be present at elevated concentrations at boundaries between the first metal and the second metal as compared to concentrations of the active metal in bulk regions of the first metal and the second metal, as evidenced by EDS measurements of the composite material.

In some embodiments, the composite can be formed by a method that comprises severe plastic deformation (SPD), such as equal channel angular extrusion (ECAE). In certain embodiments when the composite is formed by a method that comprises SPD, grains of the first metal and grains of the second metal exhibit increased co-deformation, as assessed by backscatter scanning electron microscopy (SEM), as compared to grains of the first metal and grains of the second metal in a composite containing the first metal and the second metal in an equivalent atomic ratio, but lacking the active metal.

In some embodiments, the composite exhibits improved yield strength, improved tensile strength, improved elongation to failure, improved fracture toughness, or a combination thereof as compared to a composite containing the first metal and the second metal in an equivalent atomic ratio, but lacking the active metal.

The metal-metal composites described herein can exhibit tailored microstructures and properties. These multiphase metal-metal composites can find use in a range of applications, including for example, as wear resistant conductors (e.g., for cycling electrical switches), high strength thermal conductors (e.g., for use in heat exchangers and boilers), and high-strength, wear resistant materials for miliary applications (e.g., rail gun rails, kinetic energy penetrators, and shaped charge liners).

Also provided herein are methods of preparing metal-metal composite. These methods can comprise subjecting a mixture comprising a first metal, a second metal, and an active metal to a severe plastic deformation (SPD) process, wherein the active metal is present in an effective amount to improve interphase bonding between the first metal and the second metal as compared to a composite containing the first metal and the second metal in an equivalent atomic ratio, but lacking the active metal.

In some embodiments, the mixture comprising the first metal, the second metal, and the active metal can be prepared by blending and sintering the metal, the second metal, and the active metal.

### Liquid-Solid Composites

Also provided herein are liquid-solid composites that comprise a continuous liquid phase comprising a first metal intertwined with a continuous solid refractory phase.

The liquid-solid composite can be at a temperature that is above the melting point of the first metal and below the melting point of the solid refractory phase. Differential scanning calorimetry can be used to confirm that the first metal is present in the composite in a molten state.

In some embodiments, the first metal can have a melting point that is at least 100° F. below (e.g., at least 150° F. below, at least 200° F. below, at least 250° F. below, at least 300° F. below, at least 350° F. below, at least 400° F. below, at least 450° F. below, or at least 500° F. below) the melting point of the solid refractory phase.

In some embodiments, the first metal can have a melting point of at least 400° F. (e.g., at least 500° F., at least 600° F., at least 700° F., at least 800° F., at least 900° F., at least 1,000° F., at least 1,100° F., at least 1,200° F., at least 1,300° F., at least 1,400° F., at least 1,500° F., at least 1,600° F., at least 1,700° F., at least 1,800° F., or at least 1,900° F.). In some embodiments, the first metal can have a melting point of 2,000° F. or less (e.g., 1,900° F. or less, 1,800° F. or less, 1,700° F. or less, 1,600° F. or less, 1,500° F. or less, 1,400° F. or less, 1,300° F. or less, 1,200° F. or less, 1,100° F. or less, 1,000° F. or less, 900° F. or less, 800° F. or less, 700° F. or less, 600° F. or less, or 500° F. or less).

The first metal can have a melting point ranging from any of the minimum values described above. For example, in some embodiments, the first metal can have a melting point of from 400° F. to 2,000° F.

In some embodiments, the solid refractory phase can have a melting point of at least 2,100° F. (e.g., at least 2,200° F., at least 2,300° F., at least 2,400° F., at least 2,500° F., at least 3,000° F., at least 3,500° F., at least 4,000° F., at least 4,500° F., or at least 5,000° F.). In some embodiments, the first metal can have a melting point of 6,200° F. or less (e.g., 5,000° F. or less, 4,500° F. or less, 4,000° F. or less, 3,500° F. or less, 3,000° F. or less, 2,500° F. or less, 2,400° F. or less, 2,300° F. or less, or 2,200° F. or less).

The solid refractory phase can have a melting point ranging from any of the minimum values described above. For example, in some embodiments, the solid refractory phase can have a melting point of from 2,100° F. to 6,200° F., such as from 2,500° F. to 6,200° F.

In some embodiments, the first metal can be chosen from Cu, Bi, Ca, Au, and Ag.

In some embodiments, the solid refractory phase comprises a second metal. For example, in some embodiments, the solid refractory phase can comprise a second metal chosen from Ta, Fe, steel, Nb, Mo, and W. In other embodiments, the solid refractory phase comprises a ceramic. For example, in some embodiments, the solid refractory phase can comprise a ceramic chosen from alumina, silica, and yittria.

The relative proportions of the continuous liquid phase and the solid refractory phase present in the composite can vary. In some embodiments, the continuous liquid phase comprises at least 50% by volume (e.g., at least 55% by volume, at least 60% by volume, at least 65% by volume, at least 70% by volume, at least 75% by volume, at least 80% by volume, at least 85% by volume, at least 90% by volume, or at least 95% by volume) of the liquid-solid composite. In some embodiments, the continuous liquid phase comprises 98% or less by volume (e.g., 95% or less by volume, 90% or less by volume, 85% or less by volume, 80% or less by volume, 75% or less by volume, 70% or less by volume, 65% or less by volume, 60% or less by volume, or 55% or less by volume) of the liquid-solid composite.

The amount of continuous liquid phase present in the composite can range from any of the minimum values described above to any of the maximum values described above. For example, in some embodiments, the continuous liquid phase comprises from 50% by volume to 98% by volume of the liquid-solid composite (e.g., from 60% by volume to 98% by volume of the liquid-solid composite).

This ability of these composites to exhibit certain properties of a liquid metal while still retaining their shape/structural integrity renders these composites particularly suitable for use in liquid metal batteries. Currently, liquid metal batteries are known for their efficiency and long life span. However, many liquid metal battery designs rely on buoyancy to separate their electrodes and electrolyte. As a result, many liquid metal batteries are limited to stationary applications, as movement can cause the electrodes to come into contact with one another and form an electrical short. The liquid-solid composites described herein can be used as electrodes, eliminating this problem with many existing electrodes used in liquid metal batteries.

Accordingly, provided herein is an electrode for use in an electrochemical cell comprising a liquid-solid composite described herein. Also provided are electrochemical cells comprising an anode, a cathode, and an electrolyte in electrochemical contact with the anode and the cathode; wherein the anode, the cathode, or a combination thereof comprise a liquid-solid composite described herein.

Also provided herein are liquid-solid composites comprising a continuous liquid phase comprising a molten electrolyte intertwined with a continuous solid refractory phase.

The liquid-solid composite can be at a temperature that is above the melting point of the electrolyte and below the melting point of the solid refractory phase. Differential scanning calorimetry can be used to confirm that the electrolyte is present in the composite in a molten state.

In some embodiments, the electrolyte can have a melting point that is at least 100° F. below (e.g., at least 150° F. below, at least 200° F. below, at least 250° F. below, at least 300° F. below, at least 350° F. below, at least 400° F. below, at least 450° F. below, or at least 500° F. below) the melting point of the solid refractory phase.

In some embodiments, the electrolyte can have a melting point of at least 400° F. (e.g., at least 500° F., at least 600° F., at least 700° F., at least 800° F., at least 900° F., at least 1,000° F., at least 1,100° F., at least 1,200° F., at least 1,300° F., at least 1,400° F., at least 1,500° F., at least 1,600° F., at least 1,700° F., at least 1,800° F., or at least 1,900° F.). In some embodiments, the electrolyte can have a melting point of 2,000° F. or less (e.g., 1,900° F. or less, 1,800° F. or less, 1,700° F. or less, 1,600° F. or less, 1,500° F. or less, 1,400° F. or less, 1,300° F. or less, 1,200° F. or less, 1,100° F. or less, 1,000° F. or less, 900° F. or less, 800° F. or less, 700° F. or less, 600° F. or less, or 500° F. or less).

The electrolyte can have a melting point ranging from any of the minimum values described above. For example, in some embodiments, the electrolyte can have a melting point of from 400° F. to 2,000° F.

In some embodiments, the solid refractory phase can have a melting point of at least 2,100° F. (e.g., at least 2,200° F., at least 2,300° F., at least 2,400° F., at least 2,500° F., at least 3,000° F., at least 3,500° F., at least 4,000° F., at least 4,500° F., or at least 5,000° F.). In some embodiments, the first metal can have a melting point of 6,200° F. or less (e.g., 5,000° F. or less, 4,500° F. or less, 4,000° F. or less, 3,500° F. or less, 3,000° F. or less, 2,500° F. or less, 2,400° F. or less, 2,300° F. or less, or 2,200° F. or less).

The solid refractory phase can have a melting point ranging from any of the minimum values described above. For example, in some embodiments, the solid refractory phase can have a melting point of from 2,100° F. to 6,200° F., such as from 2,500° F. to 6,200° F.

In some embodiments, the electrolyte can be chosen from one or more metal halides, one or more metal carbonates, one or more metal oxides, or a combination thereof. For example, in some embodiments, the electrolyte can be chosen from lithium chloride, potassium chloride, lithium bromide, potassium bromide, lithium iodide, potassium iodide, lithium fluoride, potassium fluoride, sodium chloride, sodium bromide, sodium iodide, sodium fluoride, lithium hexafluorophosphate, lithium carbonate, sodium carbonate, potassium carbonate, strontium carbonate, barium carbonate, magnesium carbonate, calcium carbonate, beryllium carbonate, cesium carbonate, rubidium carbonate, PbCl₂·2PbO, PbO, Bi₂O₃, Bi₂O₅, molybdenum oxide, Cs₂O, Cs₂O₃, Sb₂O₃, Sb₂O₄, Sb₂O₅, CuO, CuO₂, GeO₂, GeO, lithium oxide, palladium oxide, K₂O, KO₂, NaO₂, Na₂O₂, RbO₂, Rb₂O₃, Rb₂O₂, SnO, SnO₂, tellurium oxide, Tl₂O, Tl₂O₃, vanadium oxide, As₄O₆, As₂O₅, In₂O, In₂O₃, and mixtures thereof (e.g., eutectic mixtures of two or more of the electrolytes above).

In some embodiments, the solid refractory phase comprises a metal. For example, in some embodiments, the solid refractory phase can comprise a metal chosen from Ta, Fe, steel, Nb, Mo, and W. In other embodiments, the solid refractory phase comprises a ceramic. For example, in some embodiments, the solid refractory phase can comprise a ceramic chosen from alumina, silica, and yittria.

The relative proportions of the continuous liquid phase and the solid refractory phase present in the composite can vary. In some embodiments, the continuous liquid phase comprises at least 50% by volume (e.g., at least 55% by volume, at least 60% by volume, at least 65% by volume, at least 70% by volume, at least 75% by volume, at least 80% by volume, at least 85% by volume, at least 90% by volume, or at least 95% by volume) of the liquid-solid composite. In some embodiments, the continuous liquid phase comprises 98% or less by volume (e.g., 95% or less by volume, 90% or less by volume, 85% or less by volume, 80% or less by volume, 75% or less by volume, 70% or less by volume, 65% or less by volume, 60% or less by volume, or 55% or less by volume) of the liquid-solid composite.

The amount of continuous liquid phase present in the composite can range from any of the minimum values described above to any of the maximum values described above. For example, in some embodiments, the continuous liquid phase comprises from 50% by volume to 98% by volume of the liquid-solid composite (e.g., from 60% by volume to 98% by volume of the liquid-solid composite).

These composites can be used, for example, in electrolytes in liquid metal batteries. Accordingly, provided herein is an electrolyte for use in an electrochemical cell comprising a liquid-solid composite described herein. Also provided are electrochemical cells comprising an anode, a cathode, and an electrolyte in electrochemical contact with the anode and the cathode; wherein the electrolyte comprises a liquid-solid composite described herein.

By way of non-limiting illustration, examples of certain embodiments of the present disclosure are given below.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1: Minor Titanium Addition Markedly Improves the Co-Deformability of Copper-Tantalum Composites

### SUMMARY

In this example, we investigated the microstructure of equal channel angular extrusion (ECAE) processed sintered composites of copper (Cu) and tantalum (Ta). These composites were produced with nominal Ta volume percentages ranging from 25% to 75%. Additional composites of the same nominal Ta content were prepared with a minor amount of titanium (Ti) added to facilitate interphase bonding. Ti addition was found to markedly improve the strength and co-deformability of the composites, allowing reliable extrusion of Cu—Ta composites with new microstructures. A major influence of the Ti appears to be to soften the Ta, which contributes to improved co-deformability by reducing the flow stress mismatch between the composite constituents. The Ti may also improve cohesion by reducing Ta surface oxides,

### INTRODUCTION

Equal-channel angular extrusion (ECAE)—a close relative of equal-channel angular pressing (ECAP)—is a severe plastic deformation (SPD) method for bulk material processing. It has been used extensively for grain refinement and texture modification in single-phase metals. ECAE has unique advantages compared to other plastic deformation methods, as it produces uniform deformation in the material and does not substantially alter the work piece cross section. Furthermore, ECAE alters the microstructure of composite materials, allowing the production of tailored grain and phase morphologies.

Our interest lies in applying ECAE to composites of phase separating elements, such as copper (Cu) and tantalum (Ta). Processing these composites presents challenges in ensuring interfacial cohesion between the constituent phases and their co-deformation during extrusion. In this example, we report that titanium (Ti) additions on the ˜1 at. % level markedly improve the co-deformability of sintered Cu—Ta composites, with co-deformability quantified through observations of morphological changes in both phases.

Ti can reduce many metal oxides, including stable ones such as tantalum pentoxide. Without wishing to be bound by theory, reduction of surface oxides improves wettability and bond strength, small amounts of Ti have been added to Cu-base braze filler alloys for joining metals like Nb and Ta to improve interphase bonding. Improved bonding leads to increased strength in the brazed joints. We therefore hypothesized that Ti additions to Cu—Ta composites could perform a similar function during sintering, i.e., reduce any surface tantalum oxide that might be present and thereby improve co-deformability during ECAE by enhancing interfacial cohesion.

Ensuring co-deformation is a perennial challenge in SPD processing of composites whose constituents have substantial differences in mechanical properties. For instance, during accumulative roll bonding (ARB) of aluminum-nickel (Al—Ni) composites, stress build up in the Ni layers was found to cause the Ni to fracture during processing, eventually leading to a homogenous dispersion of Ni fragments in an Al matrix. Such instabilities have been found to originate during co-deformation as a result of dissimilar mechanical properties, leading to failure in the harder phase. This complicates SPD of Cu—Ta composites, because the two metals have substantially different mechanical properties. Ta is stronger than pure Cu under quasi-static conditions. It also possesses a higher strain hardening exponent and greater sensitivity to strain rate. We find that minor Ti additions (achieved by blending Cu and Ti powders) reduces the hardness difference between Cu and Ta, markedly enhancing their co-deformation during ECAE.

Co-deformation of Cu and Ta by ECAE is of interest since it would represent a method to produce composites with face centered cubic (FCC) and body centered cubic (BCC) phases. These composites could be used for studies of the dynamic mechanical properties of composite materials, furthering basic scientific knowledge of the subject. ECAE represents an attractive option for materials processing, as it is suitable for bulk materials. In contrast, ARB is more suited to producing plates, while other methods for producing composites with tailored microstructures, like physical vapor deposition (PVD), cannot make large volumes of material.

### Experimental

### Materials and Blending

We prepared Cu—Ta composites by blending and sintering Cu and Ta powders. We used two types of Cu powder—−150 mesh water atomized powder and −325 mesh oxide reduced powder, both from Kymera International—as well as two types of Ta powder, both −325 mesh: plasma atomized spherical powder from H. C. Starck and angular powder from Global Advanced Metals (GAM). The GAM powder was produced through the hydride-dehydride (HDH) process. As there appears to be no difference in performance between composites made with these different powder types, we used them interchangeably in our composites.

Powders were blended using a TURBULA shaker mixer, produced by Willy A. Bachofen AG (WAB). The TURBULA is optimized to produce homogeneous blends of powders with differing densities and particle sizes. Powders were blended by placing the target volume of metal powder in cylindrical latex tooling produced by Trexler Rubber and sealing the open end of the tubing with a polyurethane plug. The sealed tooling was placed within a polyvinyl chloride (PVC) tube to prevent the TURBULA's fixturing mechanism from compressing the flexible latex tooling and interfering with powder flow. This assembly was then blended in the TURBULA for 12 hours at 34 revolutions per minute (rpm).

Samples are labeled by nominal composition as CuXXTaYY, with “XX” and “YY” denoting the respective Cu and Ta nominal volume percentages. We investigate three nominal compositions: Cu75Ta25, Cu50Ta50, and Cu25Ta75. Compositions of the same nominal tantalum content but modified by the addition of Ti were denoted Cu75Ta25M, Cu50Ta50M, and Cu25Ta75M.

TABLE 1
Nominal Sample Compositions.

| | Content (wt. %) | | | Content (at. %) | | |
|---|---|---|---|---|---|---|
| Material | Cu | Ta | Ti | Cu | Ta | Ti |
| Cu75Ta25 | 61.7 | 38.3 | 0.0 | 82.1 | 17.9 | 0.0 |
| Cu50Ta50 | 34.9 | 65.1 | 0.0 | 60.5 | 39.5 | 0.0 |
| Cu25Ta75 | 15.2 | 84.8 | 0.0 | 33.8 | 66.2 | 0.0 |
| Cu75Ta25M | 60.8 | 38.3 | 0.9 | 80.5 | 17.8 | 1.6 |
| Cu50Ta50M | 34.4 | 65.1 | 0.5 | 59.4 | 39.4 | 1.2 |
| Cu25Ta75M | 15.0 | 84.8 | 0.2 | 33.2 | 66.1 | 0.7 |

### Sintering Procedure

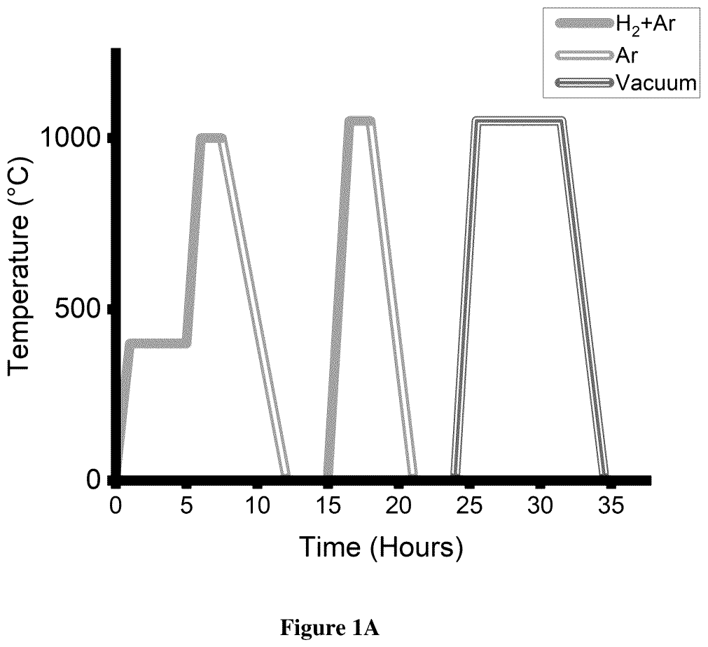

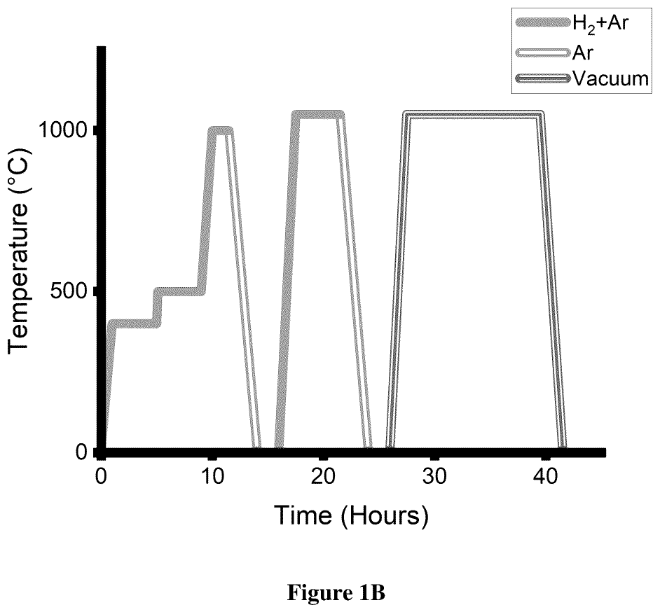

Blended powders were pressed while still in their sealed latex tooling at 170 MPa in an AIP CP360 cold isostatic press (CIP) to produce a green body with open porosity. This open porosity allows gas flow during sintering. After pressing, the green bodies were removed from the latex container and sintered in a mixed atmosphere of hydrogen and argon. Hydrogen was used during a low temperature heat treatment hold intended to reduce copper oxides (see FIGS. 1A-1B). The composite was subsequently heated to and held at 1000° C. to sinter the copper. The hydrogen flow was shut off after the 1000° C. hold and the composite cooled to room temperature under pure argon to inhibit tantalum hydride formation. The composite was then pressed in the CIP at 340 MPa. In the subsequent second sintering step, the composite was held at 1050° C., using the same atmosphere as the first step, with the hydrogen flow being again shut off prior to cooling to inhibit hydride formation. The composite was then pressed again in the CIP at 340 MPa. As a final sintering step, the composite was sintered under high vacuum at 1050° C. to allow any hydrogen dissolved in the Ta to diffuse out and be removed. All sintering was conducted in an MTI-1200x tube furnace. The composite was furnace cooled after each sintering step. After sintering, the composite diameter was typically about 15 mm while the length did not exceed 110 mm.

Ti-modified composites were prepared by substituting ˜1.5 wt. % of Ti for 1.5 wt. % Cu. This Ti content was selected to reduce Ta oxides while minimizing Cu—Ti intermetallic formation. The Ti was added in the form of titanium hydride powder prior to blending to avert Ti oxidation during fabrication. We blended and sintered the Ti-modified material using a procedure similar to that used for the unmodified material, except that, in the initial stages, an additional 240 minute hold was added at 500° C. to ensure full Ti hydride decomposition. The dwell time at 1050° C. during the second and third sintering step was also increased.

### ECAE

To prepare samples for extrusion, the sintered composites were first milled and fitted into steel cans. The cans were sized to fit within a die with a 12.7 mm×12.7 mm cross section and a maximum length of about 100 mm. They cans were made from commercially available AISI 304, AISI 4130, or A513 steel, all procured from McMaster-Carr Supply Company. Can ends were sealed with AISI 1018 or AISI 304 steel plugs by autogenous tungsten inert gas (TIG) welding using argon shielding gas. Canned samples were extruded by ECAE using a custom-built sliding wall ECAE die having a 90° angle. Extrusions were generally carried out isothermally at 600° C. with a constant speed of 1 mm/s. One exception was the 75 vol. % Ta material, where the most successful extrusions were carried out at 450° C. and 0.05 mm/s. Whenever a sample was extruded multiple times, the orientation of the work piece in the die was kept constant (i.e., no sample rotation upon successive extrusions). In the ECAE literature, such an extrusion sequence is known as “route A”.

### Microscopy

To characterize microstructure, samples were mounted in thermoset resin, wet ground, and polished. Grinding was done using successive CAMI 320, 600, and 1200 grit silicon carbide paper. Polishing was done with 15 μm polycrystalline diamond followed by 3 μm polycrystalline diamond, both in a propylene glycol suspension. Final polishing was done with 0.05 μm colloidal silica.

Imaging was performed in a Thermo Scientific Phenom XL Scanning Electron Microscope (SEM) using backscatter and secondary electron detectors and elemental mapping using energy dispersive spectroscopy (EDS).

### Mechanical Testing

Nanoindentation testing was performed on as-sintered samples at a constant test depth of 2 μm using a KLA NanoBlitz 3D. To sample local hardness variations, 256 indents are made on each tested sample. Measurements are analyzed using the Oliver-Pharr method at several depths per indent. Indents were distributed on a 16×16 grid with a spacing of 25 μm to 30 μm between adjacent indents to prevent overlap of plastically deformed zones. Additional indents were made with the same spacing in smaller grids on occasions where fewer than 241 valid points were collected in the initial grid. All reported data was from a nominal test depth of 1.6 μm, to minimize indentation size effects in the data.

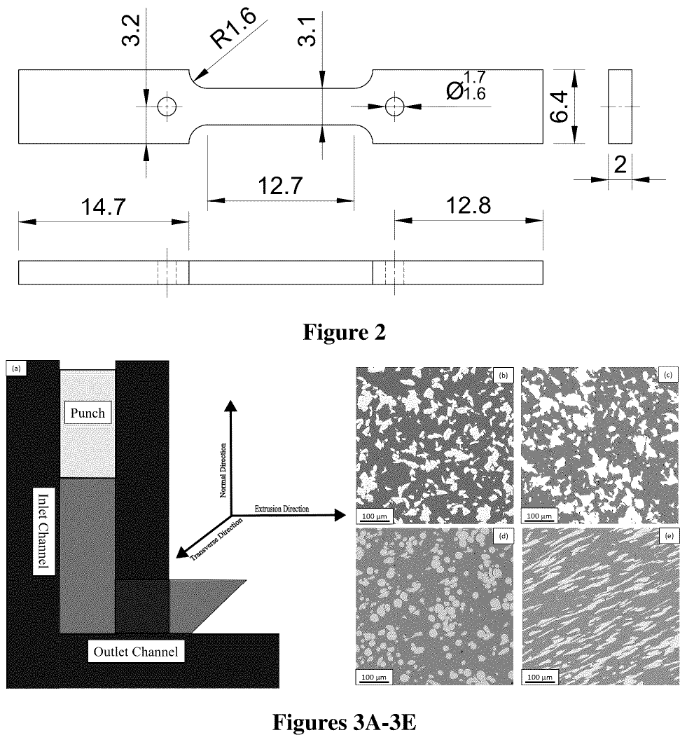

Tensile testing was conducted at a strain rate of 10⁻⁴/s using an Instron Insight 30 kN electromechanical load frame with a John A. Shepic Company contact extensometer and an MTS 30 kN load cell. FIG. 2 shows the tensile specimen design. Specimens were CNC machined in 3-axis Haas mini-mill with the gage section parallel to the work piece's long axis in as-sintered tensile samples. Fracture surfaces were examined using the same Phenom SEM used for microstructural characterization

### Results

### Microstructural Change During Extrusion

FIG. 3A and FIG. 3B show micrographs of Cu75Ta25 and Cu75Ta25M, respectively, in their as-sintered state. Both composites are well consolidated, with minimal porosity and no indications of particle pull-out during polishing. FIG. 3C and FIG. 3D show micrographs of Cu75Ta25 and Cu75Ta25M, respectively, after one extrusion (1A). In the unmodified composite, the Ta particles remain approximately equiaxed after extrusion. Thus, we conclude that the majority Cu phase deformed extensively while the Ta particles did not deform. By contrast, in the Ti modified composite, the Ta particles are sheared into elongated shapes. This observation indicates that the Ta co-deformed with Cu during extrusion. Addition of Ti has a similar effect for samples made with both angular and spherical Ta.

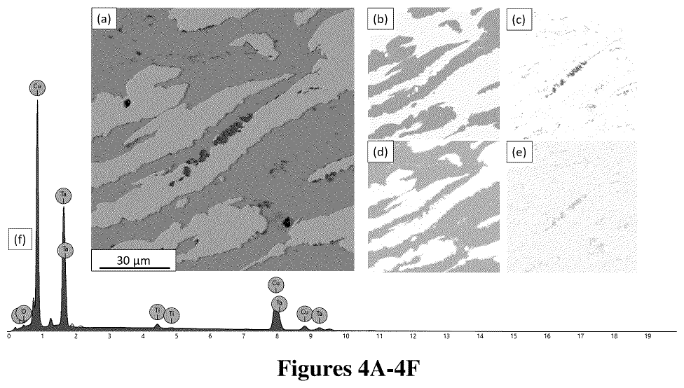

EDS measurements of extruded Cu75Ta25M indicate elevated concentrations of Ti and oxygen along Cu—Ta phase boundaries, as seen in FIGS. 4A-4E. This observation is consistent with Ti reducing the passivation layer that was likely present on the surface of the Ta particles prior to sintering. Area EDS scanning of the composite did not detect Ti in either the Cu or Ta, which suggests that the Ti concentration in the bulk of the material was below 0.5 wt. %.

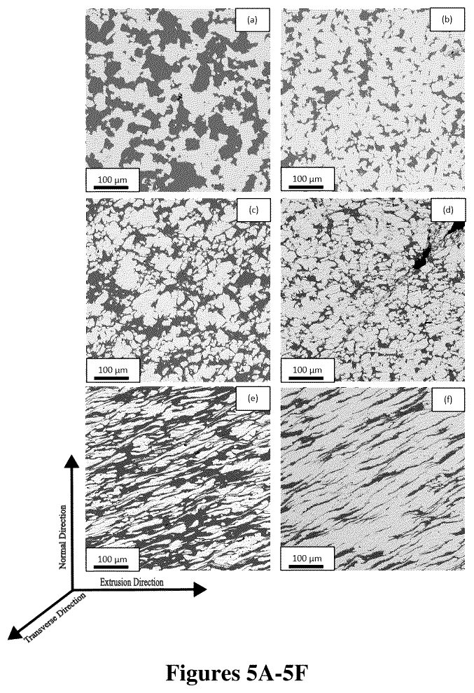

Similar to the 25 vol. % Ta material, composites with 50 and 75 vol. % Ta were well consolidated, as shown in FIG. 5A and FIG. 5B. As-sintered modified and unmodified composites have comparable phase distributions. As illustrated in FIGS. 5A-5F, Ti modified samples, Cu50Ta50M and Cu25Ta75M, exhibit co-deformation of Cu and Ta phases. By contrast, the unmodified samples, Cu50Ta50 and Cu25Ta75, show no evidence of co-deformation. In the extruded Cu50Ta50 sample, Ta particle dimensions are smaller than in the as-sintered state, suggesting that the particles break up without deforming as the Cu matrix flows plastically around them. In the extruded Cu25Ta75 sample, we see evidence of shear localization in the Cu phase as well as onset of cracking in the shear bands. Thus, it appears that plastic flow in all unmodified samples is limited to the Cu phase.

### Mechanical Properties

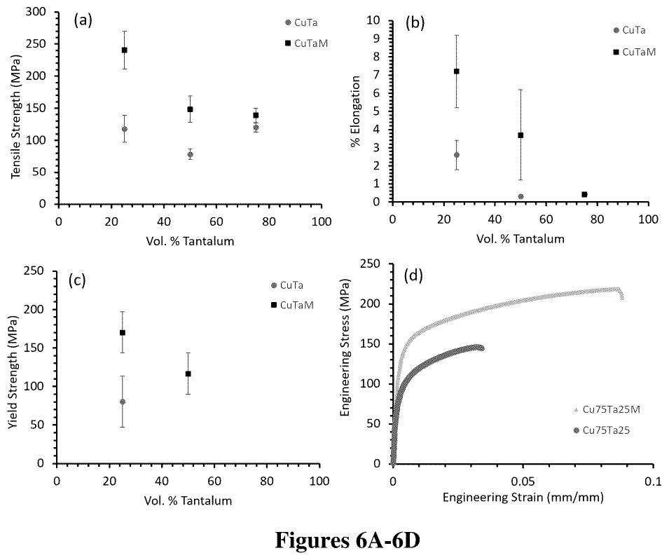

The effect of Ti modification on mechanical properties of all composite compositions is summarized in FIGS. 6A-6D. Ti-modified composites have higher yield strength and elongation to failure than the unmodified ones. Yield strengths were calculated by the 0.002 strain offset method. Several compositions did not have adequate ductility for a yield point to be found using this method. In these cases, no yield strength was reported. Tensile strength was defined as the maximum recorded engineering stress value, by elongation was given as the elongation at failure. At least three tensile tests were conducted for each composition. FIGS. 6A-6D reports averages of these tests with error bars denoting standard deviations.

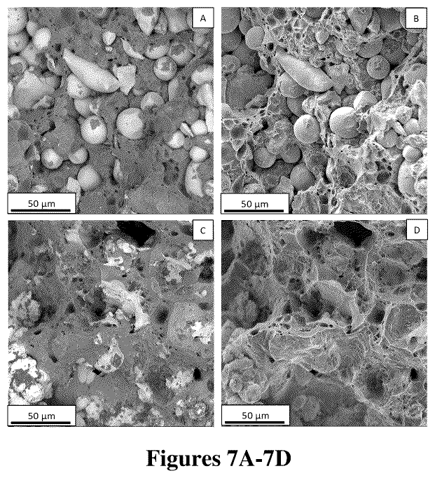

FIGS. 7A-7D show fracture surfaces of 25 vol. % Ta samples tested to failure in tension. The unmodified composite appears to have fractured through the Cu phase and along Cu—Ta phase boundaries. By contrast, the Ti-modified samples appear to have fractured through both Cu and Ta phases. This observation is consistent with increased Cu—Ta interface cohesion in the Ti-modified material, which is likely to be a major contributor to the increased tensile strength and ductility of the Ti-modified composites.

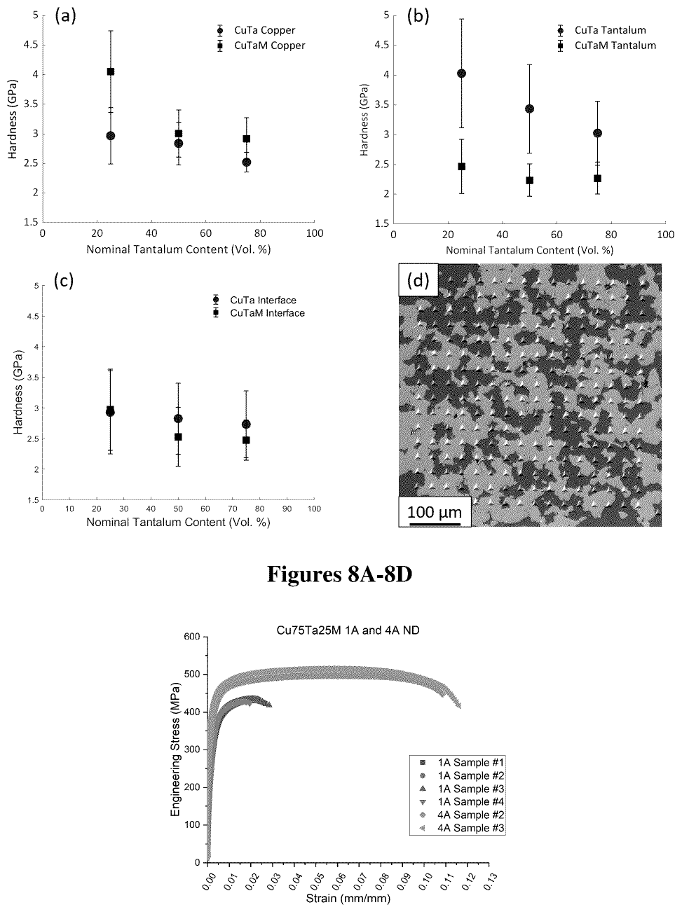

Nanoindentation reveals differences in hardness between the modified and unmodified composites. The addition of Ti hardened the Cu phase, while softening the Ta. Little difference is visible for indents that fell on copper-tantalum interfaces. As shown in FIGS. 8A-8D, the greatest change in hardness is seen in the 25% Ta material, which had the greatest amount of titanium added.

### Post-Extrusion Properties

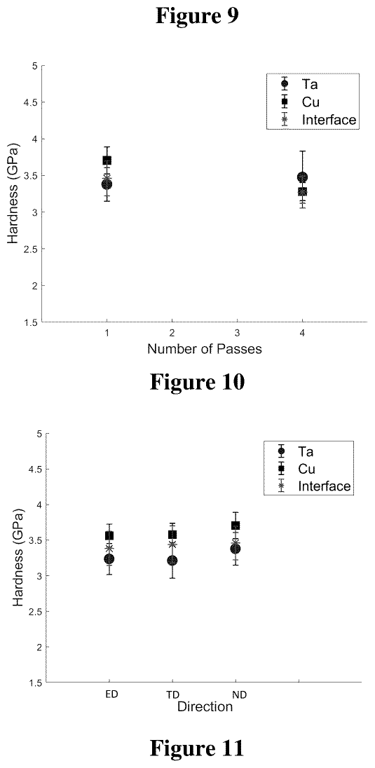

Following extrusion, the 25% tantalum composite has demonstrated substantially improved mechanical properties. Strength was similar in all orientations, but elongation at failure varied substantially. The greatest increase in strength was noted between the as sintered material and the 1A material. A noticeable increase in strength was also noted between the 1A and 4A samples for Cu75Ta25M. Ductility was also increased (see FIG. 9). In both conditions and all orientations tensile and yield strengths exceeded literature values for 6061-T6 aluminum, a widely used engineering material.

Following nano-indentation testing in the 4A Cu75Ta25M material, little change was noted when compared to the 1A material (see FIG. 10). There was also little difference in nano-hardness between sample orientations (see FIG. 11). This suggests that the improvement in mechanical properties was the result of changes in the particle morphology, rather than further working of the material. As a result, the microstructure control offered by titanium modification may represent the most efficient method of strengthening these composites.

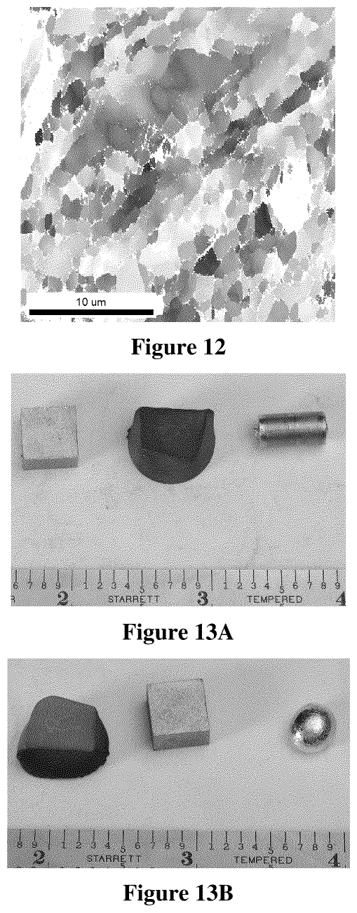

Initial electron back-scatter diffraction (EBSD) results indicate that the copper in both 1A Cu50Ta50 and 1A Cu50Ta50M was very fine-grained (see FIG. 12). Fine grain structures are known to have a variety of positive effects on materials.

### Elevated Melting Point

Several compositions, included both titanium modified and unmodified material, were heated to 1120° C. for periods of time ranging from one to twelve hours. This temperature exceeds the literature value of copper (1084° C.). No melting was observed in any of the composite samples. In addition, both 25 vol. % and 75 vol. % tantalum samples were heated to 1200° C. for one hour (see FIGS. 13A-13B). As with the 1120° C. tests, no melting was observed.

This result may be significant, as existing copper-tantalum phase diagrams do not suggest any melting copper melting point elevation. Furthermore, it could indicate that these composites will demonstrate good creep resistance, as mechanical creep rates are related to homologous temperature.

### Discussion

We have found that minor addition of Ti has a major effect on the tensile properties and extrudability of Cu—Ta composites. Compared to unmodified material, the Ti-modified composites have higher strength and greater ductility. Moreover, the Cu and Ta phases in the Ti-modified material co-deform during ECAE while, in the unmodified material, flow appears to be confined to the Cu phase. We attribute these differences to improved Cu—Ta interface cohesion due to reduction of Ta oxides by Ti and to more closely matched flow strengths due to solid solution strengthening of Cu by Ti as well as solid solution softening of Ta by Ti.

Elevated levels of Ti and oxygen at Cu—Ta interfaces in the modified material suggests the presence of titanium oxide in these regions. It is likely much of the oxygen originated in the tantalum powder, since the copper oxide present in the material would have been largely reduced by hydrogen prior to the titanium hydride decomposition. The tantalum-sourced oxygen would either have originated as an interstitial impurity or a surface oxide.

In the unmodified material, the Ta phase is consistently harder than the Cu phase. However, with the addition of Ti, the Ta hardness drops substantially, while the Cu hardens. The latter can be explained through solid solution hardening. Two mechanisms for solid solution softening in body centered-cubic (bcc) metals, such as Ta, have been proposed. In the intrinsic mechanism, the alloying element alters the kinetics of double kink nucleation and migration. In the extrinsic mechanism, Ti acts as a getter for interstitial impurities, such as oxygen. Since such interstitials are responsible for solid solution hardening, their removal leads to softening.

Our findings show that sintering is a viable method to produce bulk Cu—Ta composites with a wide range of compositions. The addition of small amounts of Ti substantially improves the mechanical properties of these composites. Furthermore, Ti addition allows the production of composites with microstructures modified through ECAE, including through different extrusion routes than the one used here. It will also identify the materials suitable for high strain rate mechanical testing, which will enable the investigation of the dynamic mechanical properties of bulk FCC-BCC composites.

### REFERENCES

[1] T. G. Langdon, Twenty-five years of ultrafine-grained materials: Achieving exceptional properties through grain refinement, Acta Materialia 61(19) (2013) 7035-7059.
[2] V. M. Segal, Equal channel angular extrusion: from macromechanics to structure formation, Materials Science and Engineering: A 271(1) (1999) 322-333.
[3] V. M. Segal, Materials processing by simple shear, Materials Science and Engineering: A 197(2) (1995) 157-164.
[4] K. Edalati, A. Bachmaier, V. A. Beloshenko, Y. Beygelzimer, V. D. Blank, W. J. Botta, K. Bryła, J. Čížek, S. Divinski, N. A. Enikeev, Y. Estrin, G. Faraji, R. B. Figueiredo, M. Fuji, T. Furuta, T. Grosdidier, J. Gubicza, A. Hohenwarter, Z. Horita, J. Huot, Y. Ikoma, M. Janeček, M. Kawasaki, P. Král, S. Kuramoto, T. G. Langdon, D. R. Leiva, V. I. Levitas, A. Mazilkin, M. Mito, H. Miyamoto, T. Nishizaki, R. Pippan, V. V. Popov, E. N. Popova, G. Purcek, O. Renk, Á. Révész, X. Sauvage, V. Sklenicka, W. Skrotzki, B. B. Straumal, S. Suwas, L. S. Toth, N. Tsuji, R. Z. Valiev, G. Wilde, M. J. Zehetbauer, X. Zhu, Nanomaterials by severe plastic deformation: review of historical developments and recent advances, Materials Research Letters 10(4) (2022) 163-256.
[5] S. Ferrasse, K. T. Hartwig, R. E. Goforth, V. M. Segal, Microstructure and properties of copper and aluminum alloy 3003 heavily worked by equal channel angular extrusion, Metallurgical and Materials Transactions A 28(4) (1997) 1047-1057.
[6] S. Biswas, S. Singh Dhinwal, S. Suwas, Room-temperature equal channel angular extrusion of pure magnesium, Acta Materialia 58(9) (2010) 3247-3261.
[7] I. J. Beyerlein, L. S. Tóth, Texture evolution in equal-channel angular extrusion, Progress in Materials Science 54(4) (2009) 427-510.
[8] S. Li, I. J. Beyerlein, D. J. Alexander, Characterization of deformation textures in pure copper processed by equal channel angular extrusion via route A, Materials Science and Engineering: A 431(1) (2006) 339-345.
[9] V. V. Stolyarov, Y. T. Zhu, I. V. Alexandrov, T. C. Lowe, R. Z. Valiev, Influence of ECAP routes on the microstructure and properties of pure Ti, Materials Science and Engineering: A 299(1) (2001) 59-67.
[10] Y. Estrin, A. Vinogradov, Extreme grain refinement by severe plastic deformation: A wealth of challenging science, Acta Materialia 61(3) (2013) 782-817.
[11] V. M. Segal, K. T. Hartwig, R. E. Goforth, In situ composites processed by simple shear, Materials Science and Engineering: A 224(1-2) (1997) 107-115.
[12] P. R. Subramanian, D. E. Laughlin, The Cu—Ta (Copper-Tantalum) system, Bulletin of Alloy Phase Diagrams 10(6) (1989) 652-655.
[13] H. Okamoto, Cu—Nb (Copper-Niobium), Journal of Phase Equilibria and Diffusion 33(4) (2012) 344-344.
[14] S. P. Garg, N. Krishnamurthy, A. Awasthi, M. Venkatraman, The O—Ta (Oxygen-Tantalum) system, Journal of Phase Equilibria 17(1) (1996) 63-77.
[15] H. Okamoto, O-Ti (Oxygen-Titanium), Journal of Phase Equilibria and Diffusion 32(5) (2011) 473-474.
[16] W. Zhao, S. Zhang, J. Yang, T. Lin, D. P. Sekulic, P. He, Wetting and brazing of YIG ceramics using Ag—CuO—TiO2 metal filler, Journal of Materials Research and Technology 10 (2021) 1158-1168.
[17] A. A. Shirzadi, H. Assadi, E. R. Wallach, Interface evolution and bond strength when diffusion bonding materials with stable oxide films, Surface and Interface Analysis 31(7) (2001) 609-618.
[18] M. H. Scott, P. M. Knowlson, The welding and brazing of the refractory metals niobium, tantalum, molybdenum and tungsten—a review, Journal of the Less Common Metals 5(3) (1963) 205-244.
[20] D. W. Liaw, R. K. Shiue, Brazing of Ti-6Al-4V and Niobium Using Three Silver-Base Braze Alloys: Physical Metallurgical and Materials Science, Metallurgical and Materials Transactions 36A(9) (2005) 2415-2427.
[20] A. Mozaffari, H. Danesh Manesh, K. Janghorban, Evaluation of mechanical properties and structure of multilayered Al/Ni composites produced by accumulative roll bonding (ARB) process, Journal of Alloys and Compounds 489(1) (2010) 103-109.
[21] J. S. Carpenter, S. C. Vogel, J. E. Ledonne, D. L. Hammon, I. J. Beyerlein, N. A. Mara, Bulk texture evolution of Cu—Nb nanolamellar composites during accumulative roll bonding, Acta Materialia 60(4) (2012) 1576-1586.
[22] S. R. Chen, G. T. Gray, Constitutive behavior of tantalum and tantalum-tungsten alloys, Metallurgical and Materials Transactions A 27(10) (1996) 2994-3006.
[23] Y. Liu, W. Xiong, Q. Yang, J.-W. Zeng, W. Zhu, G. Sunkulp, Constitutive Behavior and Processing Map of T2 Pure Copper Deformed from 293 to 1073 K, Journal of Materials Engineering and Performance 27(4) (2018) 1812-1824.
[24] C. Jing, J. Wang, C. Zhang, Y. Sun, Z. Shi, Influence of size effect on the dynamic mechanical properties of OFHC copper at micro-/meso-scales, The International Journal of Advanced Manufacturing Technology 120(7-8) (2022) 4775-4789.
[25] M. Kothari, L. Anand, Elasto-viscoplastic constitutive equations for polycrystalline metals: Application to tantalum, Journal of the Mechanics and Physics of Solids 46(1) (1998) 51-83.
[26] A. Anders, A review comparing cathodic arcs and high power impulse magnetron sputtering (HiPIMS), Surface and Coatings Technology 257 (2014) 308-325.
[27] C. G. Mccracken, D. P. Barbis, R. C. Deeter, Key characteristics of hydride-dehydride titanium powder, Powder Metallurgy 54(3) (2011) 180-183.
[28] C. Ledford, C. Rock, P. Carriere, P. Frigola, D. Gamzina, T. Horn, Characteristics and Processing of Hydrogen-Treated Copper Powders for EB-PBF Additive Manufacturing, Applied Sciences 9(19) (2019).
[29] A. San-Martin, F. D. Manchester, The H—Ta (hydrogen-tantalum) system, Journal of Phase Equilibria 12(3) (1991) 332-343.
[30] R. K. Shiue, S. K. Wu, S. Y. Chen, Infrared brazing of TiAl intermetallic using BAg-8 braze alloy, Acta Materialia 51(7) (2003) 1991-2004.
[31] C. C. Liu, C. L. Ou, R. K. Shiue, The microstructural observation and wettability study of brazing Ti-6Al-4V and 304 stainless steel using three braze alloys, Journal of Materials Science 37(11) (2002) 2225-2235.
[32] X. Ma, Y. Mao, Y. Duan, Q. Deng, G. Wang, S. Wang, Effect of Nb or Ta Interlayer on Microstructure and Mechanical Properties of Graphite/Ti6Al4V Alloy Joints, Advanced Engineering Materials 23(4) (2021) 2001237.
[33] Y. M. Liangxing Peng, Yizhong Zhang, Lixia Xi, Quanrong Deng, Geming Wang, Microstructural and mechanical characterizations of W/CuCrZr and W/steel joints brazed with Cu-22TiH2 filler, Journal of Materials Processing Technology Volume 254 (2018) Pages 346-352.
[34] H. R. Z. Sandim, B. V. Morante, P. A. Suzuki, Kinetics of thermal decomposition of titanium hydride powder using in situ high-temperature X-ray diffraction (HTXRD), Materials Research 8(3) (2005) 293-297.
[35] W. C. Oliver, G. M. Pharr, An improved technique for determining hardness and elastic modulus using load and displacement sensing indentation experiments, Journal of Materials Research 7(6) (1992) 1564-1583.
[36] W. C. O. P. Sudharshan Phani, A critical assessment of the effect of indentation spacing on the measurement of hardness and modulus using instrumented indentation testing, Materials & Design Volume 164 (2019).
[37] P. Kuisma-Kursula, Accuracy, precision and detection limits of SEM-WDS, SEM-EDS and PIXE in the multi-elemental analysis of medieval glass, X-Ray Spectrometry 29(1) (2000) 111-118.
[38] S. Nagarjuna, M. Srinivas, K. Balasubramanian, D. S. Sarma, On the variation of mechanical properties with solute content in Cu—Ti alloys, Materials Science and Engineering: A 259(1) (1999) 34-42.
[39] A. Ghafarollahi, W. A. Curtin, Theory of double-kink nucleation in dilute BCC alloys, Acta Materialia 196 (2020) 635-650.
[40] A. Seeger, Dislocation relaxation and alloy softening of bcc alloys, Philosophical Magazine Letters 90(10) (2010) 699-706.
[41] A. Seeger, U. Holzwarth†, Slip planes and kink properties of screw dislocations in high-purity niobium‡, Philosophical Magazine 86(25-26) (2006) 3861-3892.
[42] N. I. Medvedeva, Y. N. Gornostyrev, A. J. Freeman, Solid solution softening and hardening in the group-V and group-VI bcc transition metals alloys: First principles calculations and atomistic modeling, Physical Review B 76(21) (2007).
[43] V. K. Sethi, R. Gibala, Surface oxide softening of niobium single crystals, Acta Metallurgica 25(3) (1977) 321-332.
[44] R. Gibala, V. K. Sethi, R. Fournier, Obstacle-induced hardening and softening in metallic materials. Technical progress report, Feb. 1, 1976-Jan. 31, 1977, Office of Scientific and Technical Information (OSTI), 1976.
[45] R. L. Smialek, T. E. Mitchell, Interstitial solution hardening in tantalum single crystals, Philosophical Magazine 22(180) (1970) 1105-1127.

### Example 2: Liquid Solid Composites with a Refractory Phase

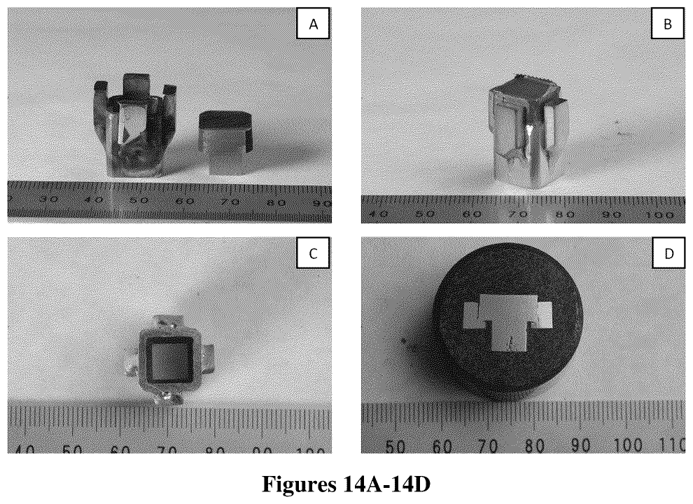

Several compositions, including both titanium modified and unmodified copper-tantalum composites, were heated to 1200° ° C. for periods of time ranging from one to twelve hours. This temperature exceeds the literature value of copper (1084° C.). No deformation was observed in any of the composite samples. No difference was noted between the modified and unmodified composites, indicating that the titanium had no role in this phenomenon. A Cu75Ta25 sample was placed in a stainless steel fixture and found to have sufficient tensile strength to be self-supporting at 1200° ° C.(see FIGS. 14A-14D).

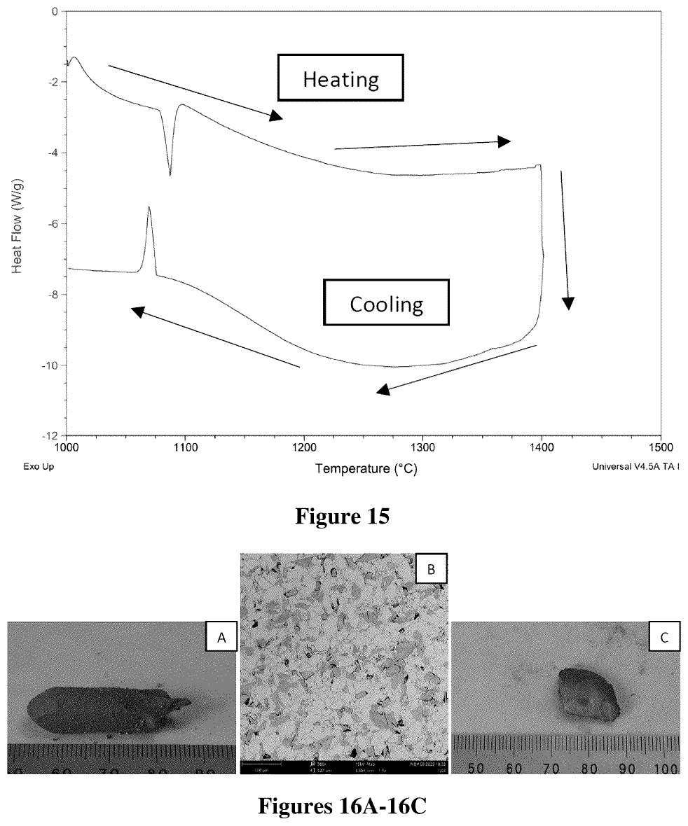

Digital scanning calorimetry (DSC) testing of Cu75Ta25 confirmed that the copper in these composites melted at the literature temperature (see FIG. 15).

An additional 75 vol. % bismuth 25 vol. % Ta composite was produced by blending bismuth and tantalum powders together, pressing them, and then sintering above the melting point of bismuth. The resulting material retained its shape during processing (see FIGS. 16A-16B). 75 vol. % calcium 25 vol. % Tantalum composite also retained its shape during sintering, though in this case calcium hydride powder was used as a precursor, rather than pure calcium (see FIG. 16C).

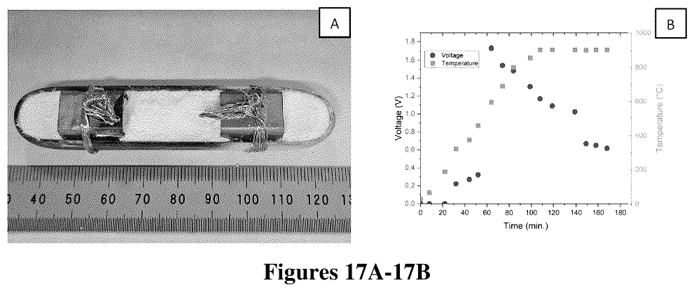

A battery was assembled using Ci75Ta25 and Ca75Ta25 composites sintered in mild steel containers in an alumina crucible (see FIG. 17A). The containers were further isolated from the crucible with yttria powder. The remaining space was filled with a mix of calcium chloride and lithium chloride electrolyte and tested at 900° C. under an inert atmosphere. The battery produced a detectable voltage that was consistent with the literature values for this system (see FIG. 17B).

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compounds, components, compositions, and method steps disclosed herein are specifically described, other combinations of the compounds, components, compositions, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. A metal-metal composite comprising a heterogeneous mixture of a first metal, a second metal, and an active metal,
wherein the active metal is present in an effective amount to improve interphase bonding between the first metal and the second metal as compared to a composite containing the first metal and the second metal in an equivalent atomic ratio, but lacking the active metal.

2. The composite of claim 1, wherein the first metal is present in the composite in an amount of from 10 at. % to 90 at. %, based on a total number of atoms present in the composite, and the second metal is present in the composite in an amount of from 90 at. % to 10 at. %, based on a total number of atoms present in the composite.

3. The composite of claim 1, wherein the first metal is chosen from Cu, Ag, and Au.

4. The composite of claim 1, wherein the second metal is chosen from Ta, Nb, V, W, Cr, and Mo.

5. The composite of claim 1, wherein the active metal is present in the composite in an amount of from 0.1 at. % to 5 at. %, based on the total number of atoms present in the composite.

6. The composite of claim 1, wherein the active metal is chosen from Ti, Zr, B, Hf, Mg, La, Sc, Y, Ce, and Be.

7. The composite of claim 1, wherein the first metal comprises Cu and the second metal comprises Ta.

8. The composite of claim 7, wherein the active metal comprises Ti.

9. The composite of claim 8, wherein the composite comprises
from 10 at. % to 90 at. % Cu, based on the total number of atoms present in the composite;
from 90 at. % to 10 at. % Ta, based on the total number of atoms present in the composite; and
from 0.1 at. % to 3 at. % Ti, based on the total number of atoms present in the composite.

10. The composite of claim 1, wherein the active metal is present at elevated concentrations at boundaries between the first metal and the second metal as compared to concentrations of the active metal in bulk regions of the first metal and the second metal, as evidenced by EDS measurements of the composite material.

11. The composite of claim 1, wherein the composite is formed by a method that comprises severe plastic deformation (SPD), such as equal channel angular extrusion (ECAE).

12. The composite of claim 11, wherein grains of the first metal and grains of the second metal exhibit increased co-deformation, as assessed by backscatter scanning electron microscopy (SEM), as compared to grains of the first metal and grains of the second metal in a composite containing the first metal and the second metal in an equivalent atomic ratio, but lacking the active metal.

13. The composite of claim 1, wherein the composite exhibits improved yield strength, improved tensile strength, improved elongation to failure, improved fracture toughness, or a combination thereof as compared to a composite containing the first metal and the second metal in an equivalent atomic ratio, but lacking the active metal.

14. A method of preparing a metal-metal composite, the method comprising subjecting a mixture comprising a first metal, a second metal, and an active metal to a severe plastic deformation (SPD) process,
wherein the active metal is present in an effective amount to improve interphase bonding between the first metal and the second metal as compared to a composite containing the first metal and the second metal in an equivalent atomic ratio, but lacking the active metal.

15. A liquid-solid composite comprising a continuous liquid phase comprising a first metal intertwined with a continuous solid refractory phase.

16. The composite of claim 15, wherein the first metal has a melting point that is at least 100° F. below a melting point of the solid refractory phase.

17. (canceled)

18. The composite of claim 15, wherein the first metal is chosen from Cu, Bi, Ca, Au, and Ag.

19. The composite of claim 15, wherein the solid refractory phase comprises a second metal
(e.g., a second metal chosen from Ta, Fe, steel, Nb, Mo, and W) or a ceramic (e.g., a ceramic chosen from alumina, silica, and yittria).

20. (canceled)

21. An electrode for use in an electrochemical cell comprising the liquid-solid composite of claim 15.

22. An electrochemical cell comprising an anode, a cathode, and an electrolyte in electrochemical contact with the anode and the cathode;
wherein the anode, the cathode, or a combination thereof comprise the liquid-solid composite of claim 15.

23-30. (canceled)
